(19) United States
(12) Patent Application Publication
(10) Pub. No.: US 2023/0113941 A1
(43) Pub. Date: Apr. 13, 2023

(54) DATA CONFIDENCE FABRIC VIEW MODELS

(71) Applicant: Dell Products L.P., Round Rock, TX (US)

(72) Inventors: Stephen J. Todd, North Andover, MA (US); Trevor Scott Conn, Leander, TX (US)

(21) Appl. No.: 17/648,514

(22) Filed: Jan. 20, 2022

Related U.S. Application Data
(60) Provisional application No. 63/253,400, filed on Oct. 7, 2021.

(51) Int. Cl. G06F 16/22; G06F 16/27; G06F 16/2455

(52) U.S. Cl. CPC G06F 16/2228; G06F 16/27; G06F 16/24568

(57) ABSTRACT

One example method includes receiving data at a node of a data confidence fabric, annotating, at the node, the data with an annotation that includes data confidence information, receiving a ledger stream at a ledger, and the ledger stream includes the annotation, and a representation of the data, creating, in a data structure associated with the ledger, a view node that corresponds to the data, creating, in the data structure, a representation of the annotation, and connecting, in the data structure, the representation of the annotation to the view node with an annotation edge.

### FIELD OF THE INVENTION

Embodiments of the present invention generally relate to data confidence fabrics. More particularly, at least some embodiments of the invention relate to systems, hardware, software, computer-readable media, and methods for viewing annotations made by a data confidence fabric to data.

### BACKGROUND

Distributed ledgers may be a useful way to store annotations made to data by a data confidence fabric (DCF). However, when it comes time to retrieve or view the annotations related to a given piece of data, for example, to calculate a confidence score based on those annotations, ledgers have proven problematic.

For example, ledgers may lack contextual value with regard to the annotations. Particularly, each entry in a ledger may contain data from a discrete moment in time which may not itself have the necessary context that makes the information valuable. For example, when a sensor of a DCF emits a reading without signing the data, it is impossible at the time to determine whether the lack of a signature is important.

Another concern with ledgers relates to ease of query and performance implications. Particularly, ledgers are not highly optimized for query-ability. As a result, annotations stored in the ledger may be inconvenient to access, and queries may not return the desired information.

Further, ledgers may be problematic with respect to the sequencing of ledger entries. Particularly, and as is often the case with an event-sourced architecture such as a DCF, it cannot be assumed that there is a guarantee that the sequencing of events, such as annotations, stored on the ledger, is correct.

Finally, a performance penalty can be expected with typical ledgers. This is because the ledger must be continuously queried for data confidence scores, which tends to slow operations.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example data confidence fabric in which example embodiments may be implemented.

FIG. 2 discloses aspects of example distributed ledger options for DCF annotation storage.

FIG. 3 discloses aspects of an example view model graph according to some embodiments.

FIG. 4 discloses an example process for initial creation of a DCF view model according to some embodiments.

FIG. 5 discloses an example full view model across and entire DCF.

FIG. 6 discloses an example calculator operations sequence according to some embodiments.

FIG. 7 discloses aspects of a computing entity operable to perform any of the claimed methods, processes, and operations.

### DETAILED DESCRIPTION OF SOME EXAMPLE EMBODIMENTS

Embodiments of the present invention generally relate to data confidence fabrics. More particularly, at least some embodiments of the invention relate to systems, hardware, software, computer-readable media, and methods for viewing annotations made by a data confidence fabric to data.

In general, example embodiments of the invention may include a mechanism for DCF view model creation. This approach may simplify application accessibility of annotations and enables greater flexibility in quickly calculating data confidence scores.

In one particular example, a sensor such as an IoT (Internet of Things) sensor, generates sensor data that comprises one or more data elements. As a data element moves through the DCF topology from an edge, to a core, to a cloud environment, each annotation of the data element by the DCF comprises a specific event describing the handling of the data at a particular node of the DCF. A calculator application may be provided that is subscribed to the ledger, which may serve as an event stream. The calculator application may be responsible for applying policies that govern the importance of each annotation in calculating the overall confidence score applicable to the data element. In addition, by virtue of subscribing to all events for the data elements of interest, the calculator may store, possibly in graphical form, relationships of a data element to the annotations of that data element. Further relationships may include revisions of data, as in transformation or filtering, and the annotations applicable to each revision. Thus, example embodiments may provide detailed insight into the lineage of data, and how confidence may have been affected by acting on the data.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, an embodiment may implement an annotation view model that supports queries by applications seeking to understand data lineage as well as overall confidence in data collected from the eco-system, while providing a granular view into which factors resulted in the total confidence score. An embodiment may provide a calculator application that employs a user-defined policy that allows some data annotations to be weighted differently than others. Finally, an embodiment may provide a view model construction that may be facilitated through any abstraction, thus providing a stream-like interface accessible by a user. Various other advantages of example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

A. Overview

Data Confidence Fabrics (DCF), use distributed annotation stores to keep track of the trustworthiness of data as the data journeys through the DCF, such as from the edge, to a core of the DCF, and to a terminal location such as a cloud site for example. This journey of the data may thus begin with the birth of the data, such as at an edge device for example, where the data is generated. The data may be passed from one node to another as it travels through the DCF, and may be annotated at each node with various confidence data and/or metadata. Further, the data, and its associated annotated confidence data, may be accessed by an application, analyzed, and employed by an application, for example.

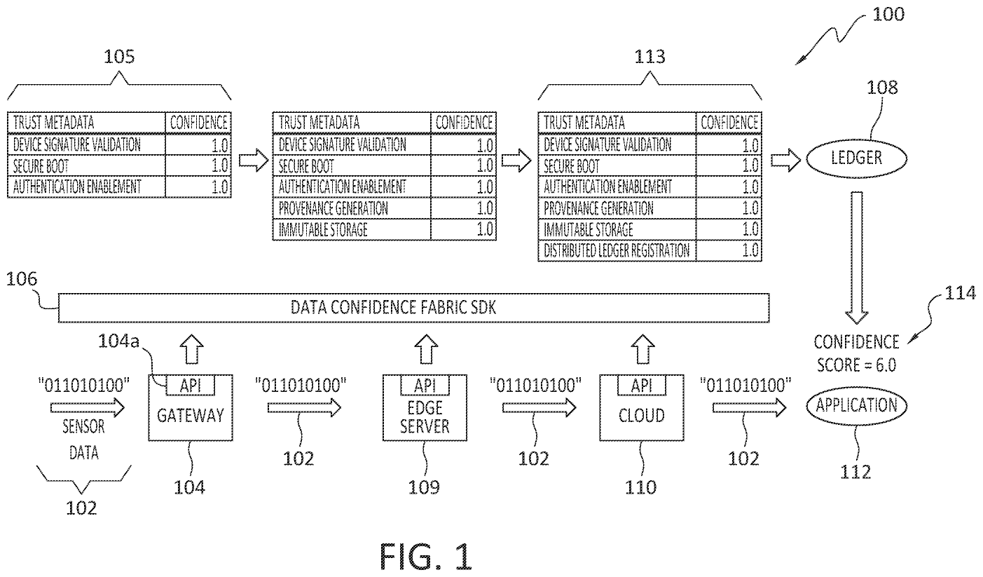

With reference now to FIG. 1, a DCF annotation and scoring framework 100 is disclosed, in association with which one or more example embodiments may be employed. In the example of FIG. 1, data 102 emanates from a source, such as an IoT sensor that is part of an edge computing environment, and is transmitted by the sensor to a gateway device 104. The gateway device 104 may annotate the data 102 with confidence information, which may comprise data and/or metadata such as trust metadata, and transmit the confidence information 105, which may also be referred to herein as ‘annotations,’ by way of an API (Application Program Interface) 104a and a DCF SDK (Software Development Kit) 106, ultimately to a ledger 108. The same process may be performed at an edge server 109, and a cloud site 110. When the data 102 arrives at a destination, or is accessed, such as by an application 112, the ledger 108 may contain an accumulation of all the annotations 113 that have been made to the data 102, and those annotations 113, and an associated confidence score 114 for the data 102, may be accessible, for example, by the application 112. In general, the confidence score 114 may be generated based on the annotations 113, or some defined subset of the annotations 113.

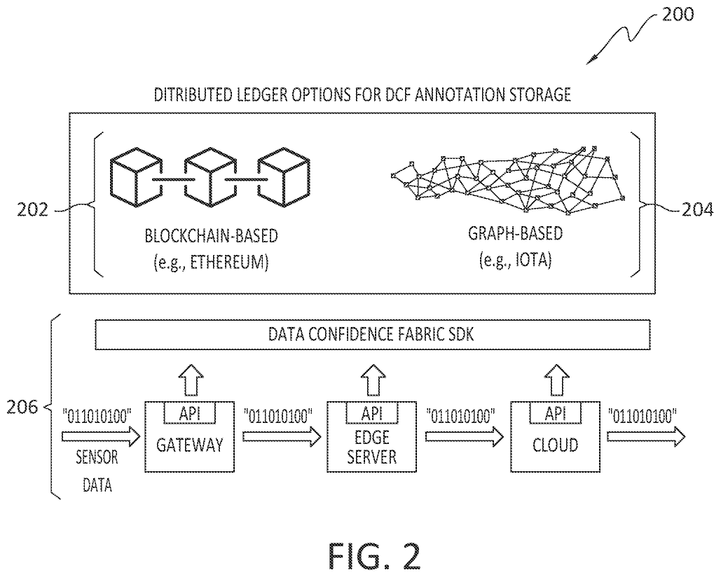

Thus, at each stage in the journey of the data 102 through the DCF 100, embodiments may enable an evaluation of a particular aspect concerning the generation and/or handling of the data 102. These evaluations are captured as annotations. With reference to the gateway device 104 as an example, the gateway device 104 may annotate the data 102, which may comprise an individual piece of data, or a stream comprising multiple pieces of data, as the data 102 traverses multiple nodes, such as the edge server 109 and cloud site 110 for example, to an eventual destination, such as the application 112 for example. In the example of FIG. 1, the gateway 104 may annotate the data 102 with the following confidence information: (1) the gateway 104 was able to validate the signature on the data 102 coming from the device; (2) the gateway 104 had undergone a secure boot process; and (3) the gateway 104 is running authentication software that does not permit anybody to inspect the data stream unless they have permission. Thus, the annotations that occur as the data 102 travels through the DCF 100 may act as inputs to a process for calculating measurable confidence concerning that data 102 at various stages of its journey. Applications, such as the example application 112, dashboards, or actuators, making use of a confidence score 114 not only have access to the sensor data 102, but it also to the score 114, as well as the list of annotations 113 that make up the score 114. As discussed below in connection with the example of FIG. 2, accessing the annotations and calculating the score may present some challenges.

FIG. 2 discloses a comparison 200 of DCF blockchain-based ledgers 202 vs graph-based ledgers 204. The comparison 200 is discussed in the context of a portion of a DCF 206. Although, as noted herein, ledgers suffer from some shortcomings, which may resolve by one or more example embodiments, ledgers, generally at least, may be well suited for use in connection with a DCF. 7, For example, ledgers may provide reliable storage at scale. Scale may be important for edge-based measurement of data confidence, as data moves from remote sensors, to gateways, to edge servers, to cloud sites. The ability to have a distributed storage system providing one namespace allows annotation to occur anywhere along the data journey.

As another example, ledger entries may be digitally signed by a unique identity. The identity of the entity creating a DCF annotation can be important. For example, an application may desire to confirm that a specific identity, such as the manufacturer of a trusted hardware component for example, generated a particular annotation. Other types of annotation stores, that is, other than ledger-based annotation stores, do not have this capability.

Further, ledger entries may undergo a validation process. To illustrate, an entity may be checking for the trustworthiness of the ledger entry itself, such as by checking for a consensus, which in turn may provide a level of confidence to an application regarding the contents of the ledger entry.

As another example, ledger entries may be immutable, at least in some cases. Particularly, a ledger entry is unchanged from the moment of its creation and cannot be removed from the ledger. This allows an application to forever check annotations associated with a specific piece of data, even if the data itself does not exist or no longer exists. This feature of a ledger may be particularly helpful in satisfying audits.

Finally, ledger entries may have unique IDs associated with them such as, for example, a hash of the content of the ledger entry. This not only helps detect tampering but also enables a method to fetch particular entries using their unique ID.

B. Detailed Aspects of Some Example Embodiments

In general, one or more of the problems disclosed herein may be solved by some example embodiments of the invention which, as discussed below, may define and implement a DCF view model. An example DCF view model may be informed by practices used extensively in event-driven architectures whereby a published view represents the totality of events collected for a given system entity or data element.

With reference to the example of FIG. 2, the data 102 may comprise the data element. As that data element moves through the DCF topology, for example, from edge to core to cloud, each annotation that is made with respect to the data 102 is a specific respective event describing the handling of the data 102 by a particular node. In example embodiments, a ‘calculator application,’ or simply ‘calculator,’ which may be the application 112 for example, is subscribed to the ledger, such as the ledger 108. The ledger may thus serve as an event stream, and is responsible for applying policies that govern the importance of each annotation in calculating the overall confidence score applicable to the data element. In addition, by virtue of subscribing to all events concerning the handling of a data element, for the data elements of interest, the calculator may store relationships of the data to its annotations as a graph. Further relationships that may be generated and stored may include revisions of data, as in transformation or filtering, and the annotations applicable to each revision. This approach by some example embodiments may provide detailed insight into the lineage of data and how confidence may have been affected by the various events involving the handling of the data.

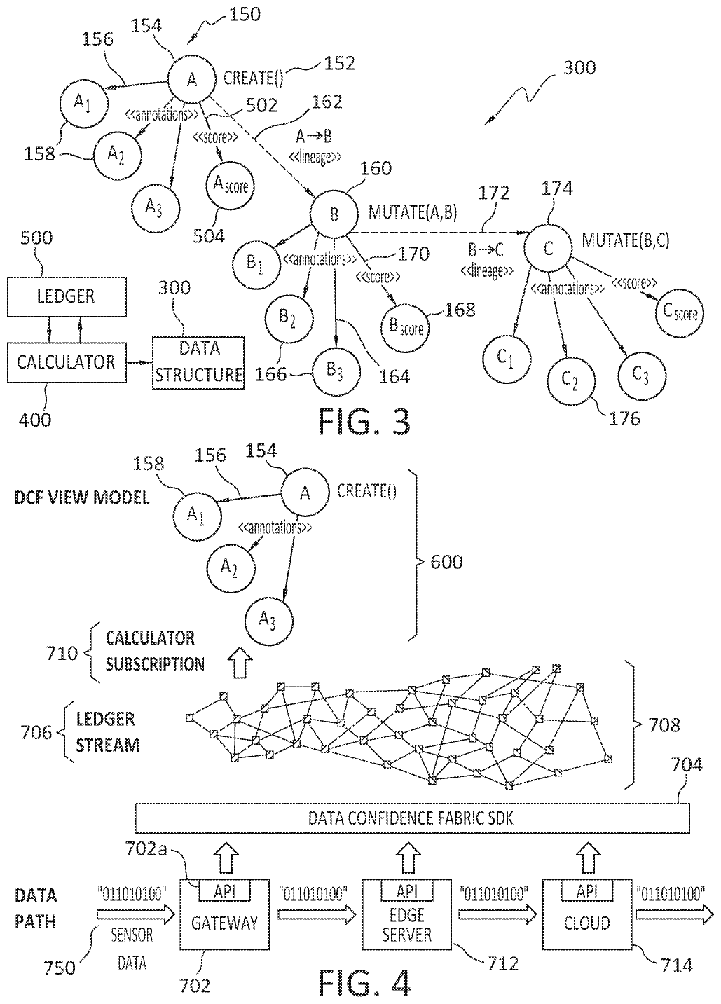

One example of an underlying data structure 300 that may be produced by a calculator 400 is disclosed in FIG. 3, which is directed to an example embodiment of a DCF view model graph. The ledger 500, which may be used to store DCF annotations and scores, is the source from which the calculator 400 reads input in order to produce a data structure 300 that may comprise a view model graph. Both the calculator 400 and the data structure 300 may be hosted as separate respective applications.

With reference briefly again to FIG. 2, and also to FIG. 3, the gateway 104 may call a ‘Create’ method 152 when a new data 102 stream arrives at the gateway 104. For example, the gateway 104, which may be publishing new events, such as creation and modification of data 102 by an entity such as an edge device (not shown) for example, to a blockchain-based ledger, may call the API 104a, which may be a ‘Create’ DCF API. The API 104a may publish a new event, corresponding to the new data 102 received at the gateway 104, into the ledger stream, that is the stream of data and annotations flowing through the DCF to the ledger 500. Because the calculator 400 may subscribe to the ledger stream, the calculator 400 may use the new event as a basis to create a corresponding view node 154 ‘A’ in the data structure 300. That is, the view node 154 may correspond to the new data 102 received at the gateway 104.

As indicated in FIG. 3, the data 102 to which the view node 154 corresponds may have been annotated 156 with various annotations 158 as the data 102 moved through various nodes of the DCF. The calculator 400 may use the annotations 158 in the ledger 500 as a basis to generate 502 a confidence score 504 that may be associated, by the calculator 400, with the view node 154 and, thus, with the data 102. It is noted that in the data structure 300, 156 may further comprise or constitute an edge indicating a relation between the annotation 158 and the data 102 represented by the view node 154. Similarly, 502 may further comprise or constitute an edge indicating a relation between the confidence score 504 and the data 102 represented by the view node 154. In this way, new data and its associated annotations and confidence score may be represented in the data structure 300.

From time to time, data, such as data 102 that is represented in the data structure 300 by the view node (A) 154, may be modified, such as by one of the nodes in the DCF and/or by the addition of further annotations, as the data 102 passes through different portions of a DCF. With reference to the example of FIG. 3, the data 102 represented by the view node (A) 154 may be modified in some way by a device downstream of the gateway 104, such as the edge server 109. The data structure 300 may then be modified to reflect this change to the data 102.

Particularly, a ‘Mutate’ (X, Y) method may call the ‘Create’ method internally, that is, internal to the ledger 500, to create a new view node (B) 160 that represents the modified data that was created. Thus, in this particular example, the mutate function is of the form ‘Mutate’ (A, B). Because the data represented by view node (B) 160 is related to the data represented by view node (A) 154, the method may also create a ‘lineage’ edge 162 in the data structure 300 indicating a relationship between the data represented by view node (B) and the data represented by view node (A) 154. That is, the relationship in this example is that the data represented by view node (B) 160 is a modification of the data represented by view node (A) 154. Similar to the case of view node (A) 154, the data associated with the view node (B) 160 may have been annotated 164 with various annotations 166 that may be used to generate a confidence score 168 pertaining to the data represented by the view node (B) 160. The confidence score 168 may be linked to the view node (B) by a ‘score’ edge 170. As further indicated in FIG. 3, any number of mutations may be performed, as exemplified by the ‘Mutate’ (B, C) function which may be performed in a manner analogous to ‘Mutate’ (A, B).

Reference is next made to FIG. 4 which discloses an example approach for initial creation of a DCF view model 600. Particularly, FIG. 4 depicts the creation of a DCF view model 600 when a new data stream arrives at a gateway 702. In the example of FIG. 4, the DCF SDK 704 is publishing data events to IOTA ledger streams 706, which is supported by an underlying graph-based ledger 708 sometimes referred to as the IOTA Tangle.

In this example, the gateway 702 may, after receipt of the new data 750, call the “Create( )” DCF API 702a, which may then publish a new data event into the IOTA ledger streams 706, resulting in the creation of a new ledger entry in the IOTA Tangle 708. A calculator, such as the calculator 400 of FIG. 3, may subscribe to the IOTA ledger streams 706, by way of a calculator subscription 710, enabling the creation of a view node, such as node (A) 154 in FIG. 3. Any subsequent annotations 158 that may be created by the gateway 702 may result in an association with the parent node (A) 154 in the DCF view model 600.

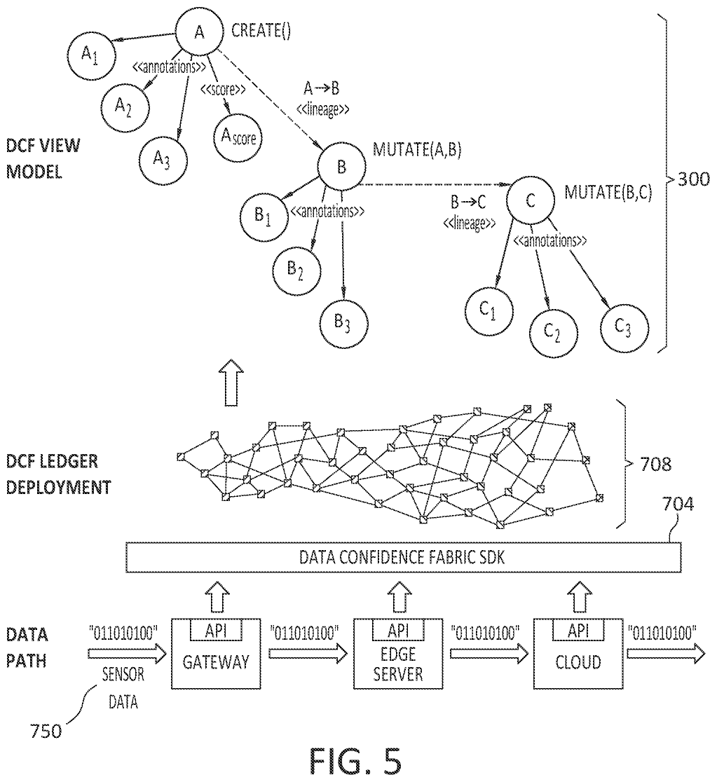

As the data 750 transits to the edge server 712 from the gateway 702 and is modified, view node (B) 160 may be created, with annotations B1-B3 attached. A similar process occurs after the data gets modified on a cloud node 714 downstream of the edge server 712, resulting in the creation of view node (C) 174 (see FIG. 3) and corresponding annotations 176 (C1-C3). FIG. 5, which references only selected elements of FIGS. 3 and 4, depicts the final result of the processes indicated in FIGS. 3 and 4. As shown in FIG. 5, the various mutations may each create a respective lineage edge, such as the lineage edges 162 and 172, between a node and the parent that went before that node. Further, for the respective data corresponding to any of the nodes (A), (B) and (C), a calculator may evaluate the associated annotations, 158 (A1-A3), 166 (B1-B3), and 176 (C1-C3), to determine if the criteria indicated by those annotations was satisfied as the corresponding data transited the DCF.

In general then, modifications to the data and/or to its annotations, as the data transits a DCF, may result in creation of one or more new view nodes, such as in a view model graph for example, where each view node corresponds to a respective state and configuration of the data as that data existed at a particular time and/or location in the DCF.

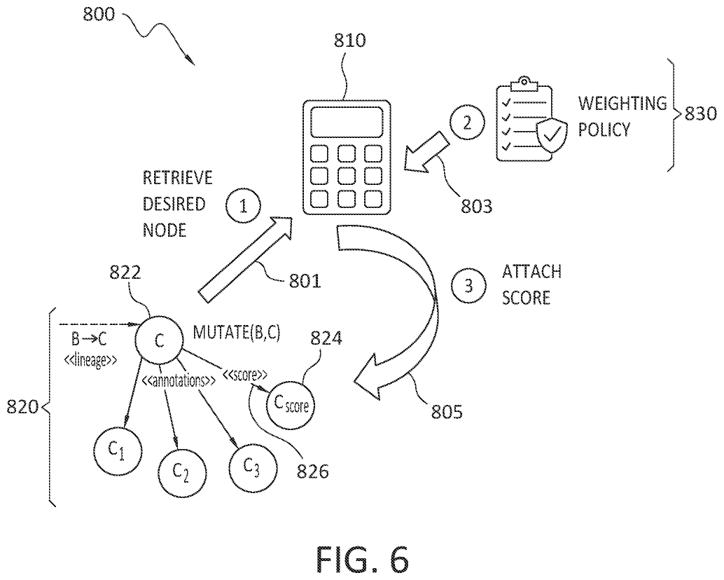

With reference next to FIG. 6, details are provided concerning the use of an example DCF view model and, particularly, a calculator operations sequence. In the example configuration 800 of FIG. 6, a calculator 810 is disclosed that is operable to walk a DCF view model 820, gather annotations and their satisfaction criteria, and then create a score based on a policy 830.

In more detail, suppose that the calculator 810 needs to locate view node (C) 822 in order to attach a confidence score to the view node 822. Once view node (C) 822 has been located 801, any annotations associated with view node (C) 822 may be inspected to determine whether or not the criteria associated with those annotations have been satisfied.

As noted elsewhere herein, each annotation may comprise or refer to a specific event concerning the handling of data by a particular DCF node. To illustrate, an annotation may specify, as one or more of its criteria, that a gateway through which the data passes should have undergone a secure boot process. If the gateway has undergone a secure boot process prior to handling the data, that is, the criterion has been satisfied, a corresponding confidence annotation may indicate a relatively high level of confidence for that particular data at that particular node. On the other hand, if the gateway has not undergone a secure boot process prior to handling the data, it is possible that the gateway may be compromised in some way, and the corresponding confidence annotation may indicate a relatively low level of confidence, at least with regard to data security, for that particular data at that particular node.

With continued reference to FIG. 6, the calculator 810 may also access 803 a weighting policy 830, one example implementation of which may be an open policy agent, discussed below. The weighting policy 830 may enable the calculator 810 to apply an equation against the retrieved annotations C1, C2 and C3. This, in turn, may enable the calculator 810 to apply a relative “importance” level to certain annotations. For example, it may be more important to a given customer that all hardware in the data collection path leverage a TPM (trusted platform module chip) for protecting secrets, in which case, this annotation should be a relatively weightier, or more ‘important,’ factor in the confidence score calculation for the data represented by the view node (C) 822. Application of this weighting may result in a confidence score 824 that may be attached 805 by a ‘score’ edge 826 to view node (C) 822 in the DCF view model 820.

Definition of the weighting policy 830 may be driven, for example, through configuration, or through integration with an Open Policy Agent (https://www.openpolicyagent.org/). In either case, the policy definition may be persisted, such as in source control where changes to the data are tracked and managed, for historical context as to why a given score was calculated for a given range of factors on a particular day, or other time. This approach may help to ensure auditability for the system.

Once calculated, the resulting score is then stored in the graph as a view node 824 linked to its respective data view node through a “score” edge 826, as noted above. When an application seeks to query the confidence score for a piece of data, the data element must be hashed using the same algorithm that hashed that data at the time the data was captured by the edge device, or other data generator. This hash may then serve as a lookup key for the data element, that is, the corresponding view node, in the DCF view model 820, and the “score” edge 826 may then be traced out to obtain the resulting score 824.

Further Discussion

As will be apparent from this discussion, example embodiments may possess various useful features. For example, embodiments may provide for a synchronous construction of view model supporting query-ability by other applications seeking to understand data lineage as well as overall confidence in data collected from the eco-system, with a granular view into which factors resulted in the total confidence.

As another example, embodiments may implement a calculator application that makes use of a user-defined policy that allows some annotations to be weighted differently, such as more or less, than other annotations. This policy may be version controlled and provide context for score calculations over time.

As a final example, embodiments may provide that view model construction may be facilitated through any abstraction providing a stream-like interface. This approach may allow for interaction with a wide range of ledgers, and ledger types, that may natively support event streaming, such as IOTA Streams, or smart contracts which can be wrapped by a library to mimic streaming behavior. By extension, embodiments may also support any native streaming channel, examples of which include, but are not limited to, Kafka, Pravega or MQTT.

### D. Example Methods

It is noted with respect to the example method of the Figures that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

### E. Further Example Embodiments

Following are some further example embodiments of the invention. These are presented only by way of example and are not intended to limit the scope of the invention in any way.

Embodiment 1. A method, comprising: receiving data at a node of a data confidence fabric; annotating, at the node, the data with an annotation that includes data confidence information; receiving a ledger stream at a ledger, and the ledger stream includes the annotation, and a representation of the data; creating, in a data structure associated with the ledger, a view node that corresponds to the data; creating, in the data structure, a representation of the annotation; and connecting, in the data structure, the representation of the annotation to the view node with an annotation edge.

Embodiment 2. The method as recited in embodiment 1, wherein the node at which the data is received comprises a gateway, and the creating of the view node and the creating of the representation of the annotation are performed in response to a ‘create’ function called by the gateway.

Embodiment 3. The method as recited in any of embodiments 1-2, wherein the data structure comprises a view model graph.

Embodiment 4. The method as recited in any of embodiments 1-3, wherein the creating of the view node and the creating of the representation of the annotation are performed by a calculator that is subscribed to the ledger stream.

Embodiment 5. The method as recited in embodiment 4, wherein the calculator subscribes to all events in the ledger stream that affect the data.

Embodiment 6. The method as recited in any of embodiments 1-5, further comprising: receiving modified data that comprises a modification of the data; invoking, by a calculator, a ‘mutate’ function that creates, in the data structure, a new view node that corresponds to the modified data, and the ‘mutate’ function further creates a lineage edge connecting the view node to the new view node.

Embodiment 7. The method as recited in any of embodiments 1-6, wherein the ledger is effectively a stream abstraction that facilitates publish and subscribe for data confidence-related events, and the supporting technology behind the stream could be any of the following—blockchain-based ledger, graph-based ledger, traditional pub/sub solution (MQTT, Kafka, Pravega).

Embodiment 8. The method as recited in any of embodiments 1-7, further comprising generating a confidence score and connecting with a score edge, in the data structure, the confidence score with the node.

Embodiment 9. The method as recited in any of embodiments 1-8, further comprising using a calculator to: locate the node; retrieve the annotation; access a weighting policy; and apply, based on the weighting policy, a weight to the annotation, to create a weighted annotation.

Embodiment 10. The method as recited in embodiment 9, further comprising creating, for the node, a confidence score, and the confidence score is based in part on the weighted annotation.

Embodiment 11. A system for performing any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

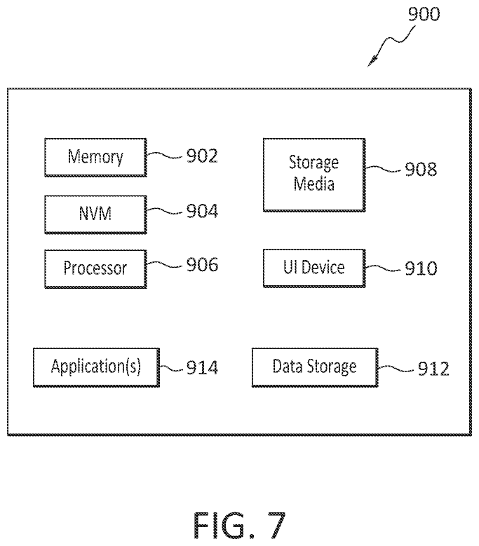

With reference briefly now to FIG. 7, any one or more of the entities disclosed, or implied, by FIGS. 1-6 and/or elsewhere herein, may take the form of, or include, or be implemented on, or hosted by, a physical computing device, one example of which is denoted at 900. As well, where any of the aforementioned elements comprise or consist of a virtual machine (VM), that VM may constitute a virtualization of any combination of the physical components disclosed in FIG. 7.

In the example of FIG. 7, the physical computing device 900 includes a memory 902 which may include one, some, or all, of random access memory (RAM), non-volatile memory (NVM) 904 such as NVRAM for example, read-only memory (ROM), and persistent memory, one or more hardware processors 906, non-transitory storage media 908, UI device 910, and data storage 912. One or more of the memory components 902 of the physical computing device 900 may take the form of solid state device (SSD) storage. As well, one or more applications 914 may be provided that comprise instructions executable by one or more hardware processors 906 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving data at a node of a data confidence fabric;
annotating, at the node, the data with an annotation that includes data confidence information;
receiving a ledger stream at a ledger, and the ledger stream includes the annotation, and a representation of the data;
creating, in a data structure associated with the ledger, a view node that corresponds to the data;
creating, in the data structure, a representation of the annotation; and
connecting, in the data structure, the representation of the annotation to the view node with an annotation edge.

2. The method as recited in claim 1, wherein the node at which the data is received comprises a gateway, and the creating of the view node and the creating of the representation of the annotation are performed in response to a ‘create’ function called by the gateway.

3. The method as recited in claim 1, wherein the data structure comprises a view model graph.

4. The method as recited in claim 1, wherein the creating of the view node and the creating of the representation of the annotation are performed by a calculator that is subscribed to the ledger stream.

5. The method as recited in claim 4, wherein the calculator subscribes to all events in the ledger stream that affect the data.

6. The method as recited in claim 1, further comprising:
receiving modified data that comprises a modification of the data; and
invoking, by a calculator, a ‘mutate’ function that creates, in the data structure, a new view node that corresponds to the modified data, and the ‘mutate’ function further creates a lineage edge connecting the view node to the new view node.

7. The method as recited in claim 1, wherein the ledger is a blockchain-based ledger, or a graph-based ledger.

8. The method as recited in claim 1, further comprising generating a confidence score and connecting with a score edge, in the data structure, the confidence score with the node.

9. The method as recited in claim 1, further comprising using a calculator to:
locate the node;
retrieve the annotation;
access a weighting policy; and
apply, based on the weighting policy, a weight to the annotation, to create a weighted annotation.

10. The method as recited in claim 9, further comprising creating, for the node, a confidence score, and the confidence score is based in part on the weighted annotation.

11. A non-transitory storage medium having stored therein instructions that are executable by one or more hardware processors to perform operations comprising:
receiving data at a node of a data confidence fabric;
annotating, at the node, the data with an annotation that includes data confidence information;
receiving a ledger stream at a ledger, and the ledger stream includes the annotation, and a representation of the data;
creating, in a data structure associated with the ledger, a view node that corresponds to the data;
creating, in the data structure, a representation of the annotation; and
connecting, in the data structure, the representation of the annotation to the view node with an annotation edge.

12. The non-transitory storage medium as recited in claim 11, wherein the node at which the data is received comprises a gateway, and the creating of the view node and the creating of the representation of the annotation are performed in response to a ‘create’ function called by the gateway.

13. The non-transitory storage medium as recited in claim 11, wherein the data structure comprises a view model graph.

14. The non-transitory storage medium as recited in claim 11, wherein the creating of the view node and the creating of the representation of the annotation are performed by a calculator that is subscribed to the ledger stream.

15. The non-transitory storage medium as recited in claim 14, wherein the calculator subscribes to all events in the ledger stream that affect the data.

16. The non-transitory storage medium as recited in claim 11, wherein the operations further comprise:
receiving modified data that comprises a modification of the data; and
invoking, by a calculator, a ‘mutate’ function that creates, in the data structure, a new view node that corresponds to the modified data, and the ‘mutate’ function further creates a lineage edge connecting the view node to the new view node.

17. The non-transitory storage medium as recited in claim 11, wherein the ledger is a blockchain-based ledger, or a graph-based ledger.

18. The non-transitory storage medium as recited in claim 11, wherein the operations further comprise generating a confidence score and connecting with a score edge, in the data structure, the confidence score with the node.

19. The non-transitory storage medium as recited in claim 11, wherein the operations further comprise using a calculator to:
locate the node;
retrieve the annotation;
access a weighting policy; and
apply, based on the weighting policy, a weight to the annotation, to create a weighted annotation.

20. The non-transitory storage medium as recited in claim 19, wherein the operations further comprise generating a confidence score for the node and attaching the confidence score to the node with a score edge, and the confidence score is based in part on the weighted annotation.
